(19) United States
(12) Patent Application Publication
(10) Pub. No.: US 2010/0266851 A1
(43) Pub. Date: Oct. 21, 2010

(54) Sealed HVOF carbide coating

(76) Inventors: Walter W. Aton, III, Kansas City, MO (US); Donald R. Spriggs, Overland Park, KS (US)

Correspondence Address: ROPES & GRAY LLP, PATENT DOCKETING 39/41, ONE INTERNATIONAL PLACE, BOSTON, MA, 02110-2624, US

(21) Appl. No.: 12/386,508

(22) Filed: Apr. 17, 2009

(51) Int. Cl. B32B 15/08; B05D 3/00; B05D 5/00; C08K 3/10; C08K 3/14

(52) U.S. Cl. 428/418; 427/372.2; 427/355; 524/407; 524/406

(57) ABSTRACT

Sealing a thermal spray coating with an extensively diluted sealant, such as a thermosetting epoxy resin, allows the sealant to more effectively protect the coating against leakage, wear and corrosion. The dilution of the sealant is believed to enhance penetration of the sealant into the coating. Such sealed coatings are useful in oilfield applications.

### BACKGROUND OF THE INVENTION

Coatings resulting from the thermal spray of metallurgical powders are widely used in industry to impart resistance to wear, erosion, and corrosion. In recent years the techniques of high velocity oxygen-fuel deposition, or HVOF, have become popular as a means of applying thermal spray coatings. The coatings that result are dense, and highly wear resistant. Some of the best wear resistant HVOF coatings are based upon tungsten carbide as a wear resistant constituent, supported in a matrix of cobalt and chromium.

Although the HVOF coatings are dense and resistant to wear, they are not fully dense. The nature of the thermal spray process and the use of powder precursors results in what is known as microporosity under even the best process conditions.

In certain environments such as in oilfield pipeline service, the HVOF thermal spray coatings are subjected to high pressure corrosive gases and liquids, as well as wear and erosion. It has been determined through simulation testing that the “as-sprayed” coatings are not sufficiently durable, largely due to the microporosity of the HVOF coatings.

Thermosetting epoxies are widely used in industry to seal surfaces. They are also known as potting compounds or sealants. As formulated and processed according to manufacturer's instructions, these epoxies by themselves are inadequate for protection of HVOF coatings. Accordingly, it would be advantageous to develop a process whereby the epoxies better protect HVOF coatings.

### SUMMARY OF THE INVENTION

It has now been recognized that epoxy coatings are excessively viscous as applied to thermal spray coatings such as HVOF coatings, such that they tend to remain on the surface to which they are applied, where they solidify and cure without penetrating the coating.

The invention, in one embodiment, provides a means of enhancing the performance of a thermal spray coating by extensively diluting a thermosetting sealant by a suitable solvent and applying the sealant to the coating. While Applicants do not wish to be bound by theory, it is believed that the extensive dilution of the sealant allows adequate penetration of the sealant below the surface of the coating and into the coating structure. In certain embodiments, the performance of the coating is enhanced by thermal processing to cure and fully seal the surface.

In another embodiment, the invention provides a duplex coating system comprising a thermal spray (HVOF) coating in combination with a thermally-cured sealant, where the sealant penetrates the coating. One application of such a duplex coating system is a gate valve, such as a gate valve suitable for oilfield use, where one or more surfaces of the gate valve include the duplex coating system.

The invention additionally provides a method of preparing the duplex coating systems described herein.

Advantages of the present invention include improving the wear-resistance of HVOF coatings, particularly those coatings exposed to high pressure gases and liquids (i.e., fluids), corrosive gases and liquids, wear, erosion and combinations thereof.

### BRIEF DESCRIPTION OF THE DRAWINGS

The invention may be better understood from the following illustrative description with reference to the following drawings.

FIG. 1 shows a sealed thermal spray coated surface of the invention.

FIG. 2 is a flow chart of sealing a thermal spray coated surface.

FIG. 3 is a flow chart of optional post-sealant application steps.

FIG. 4 is a schematic cross-section of a gate valve.

### DETAILED DESCRIPTION OF THE INVENTION

To provide an overall understanding of the invention, certain illustrative embodiments will now be described, including sealed thermal spray coatings and methods for sealing a thermal spray coating. However, it will be understood by one of ordinary skill in the art that the compositions and methods described herein may be adapted and modified as is appropriate for the application being addressed and that compositions and methods described herein may be employed in other suitable applications, and that such other additions and modifications will not depart from the scope thereof.

The invention provides compositions that include a thermal spray coating and a thermally-cured sealant, where the sealant penetrates the coating sufficiently to be resistant to one or more of high pressure gases and liquids (e.g., nitrogen), corrosive gases and liquids (e.g., hydrogen sulfide, salt-containing steam or spray), wear and erosion. In certain embodiments, this resistance has a duration of at least 500 hours, 1000 hours, 1500 hours or even 2000 hours.

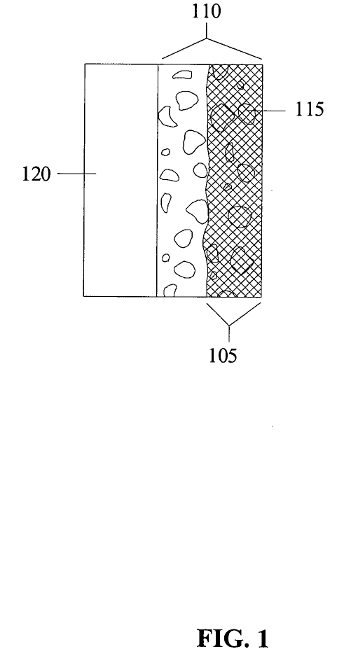

A sealant advantageously penetrates to a distance in excess of 0.05 mm, particularly when the thermal spray coating has a thickness of 0.05 mm to 0.18 mm. A representation of a sealed thermal spray coating is shown in FIG. 1, where the thermal spray coating 110 has been applied to a substrate 120, and then a sealer has been applied to the surface of the thermal sprayed coating 110 and has penetrated into the coating and pores 115 to create a sealant affected zone 105 in excess of 0.05 mm thickness from the thermal spray coating surface.

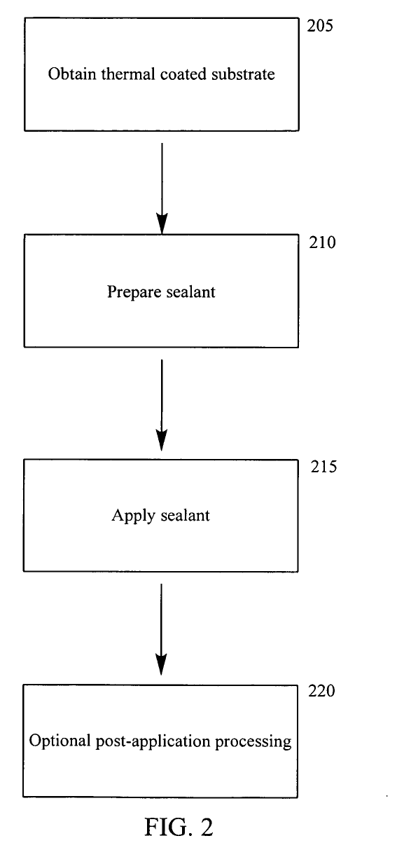

FIG. 2 is a block diagram of a method for applying a sealant to a thermal spray coating 200. The method involves obtaining a thermal spray coated substrate 205, preparing the sealant 210, applying the sealant 215 and optionally further processing the thermal spray coating and substrate after application of the sealant 220.

First, a thermal spray coated substrate is obtained 205. In certain embodiments, the thermal spray coating is an HVOF coating. In other embodiments, the thermal spray coating is a plasma spray coating or detonation coating. Suitable thermal spray coatings include carbide coatings, such as tungsten carbide coatings. Such coatings are described in, for example, U.S. Pat. Nos. 4,626,576 and 4,626,477, the contents of which are incorporated herein by reference. Tungsten carbide coatings may contain additional components, such as one made from a powder that is tungsten carbide-cobalt-chromium. Examples of these coatings consist essentially of from about 4.0 to about 10.5 weight percent cobalt, from about 5.0 to about 11.5 weight percent chromium, from about 3.0 to about 5.0 weight percent carbon and the balance tungsten; or consists essentially of from about 6.5 to about 9.0 weight percent cobalt, from about 2.0 to about 4.0 weight percent chromium, from about 3.0 to about 4.0 weight percent carbon and the balance tungsten. In certain embodiments, the powder is prepared to reduce the iron level to below one weight percent, for example, a WC-10Co-4Cr coating that contains no more than one percent by weight of iron. Other thermal spray coatings that can be sealed as described herein include, but are not restricted to, tungsten carbide-cobalt, titantium carbide-iron, titantium carbide-cobalt-chrome and chrome carbide-nickel chrome.

The substrate underlying the thermal spray coating can be any suitable substrate, including various steels such as stainless steel and carbon steel, as well as aluminum and nickel alloys.

Second, a sealant is prepared 210. In certain embodiments, the thermally-cured sealant is a thermosetting epoxy resin. In general, suitable epoxy reins are often capable of fully wetting a coated surface without drying or stiffening prematurely, and also cure effectively (e.g., according to the manufacturer's specifications). Preferably, the epoxy contains less than 5%, 3%, 2%, 1% or 0.5% by weight of halogens and/or sulfur. Suitable sealants include those which are amenable to solvent dilution prior to curing without compromising the ability to seal, particularly thermosetting epoxy resins. Examples of such sealants include Eli-Cote FR1011/HT, SPI Araldite 6005, Masterbond EP19HT, Cotronics EE-4460 series Epoxy and Cotronics EE-4461 series Epoxy.

Suitable solvents for diluting sealants of the invention include hydrophilic polar solvents, preferably those without halogens or sulfur. Examples of suitable solvents include ketones (e.g., acetone, ethyl ketone, methyl ethyl ketone), alcohols (e.g. methanol, ethanol, n-propanol, iso-propanol), acetonitrile, dioxane, tetrahydrofuran, and dimethylformamide. In certain embodiments, aromatic, nonpolar solvents such as benzene, toluene and xylenes may be used. In particular, acetone is a suitable solvent for Masterbond EP19HT, Cotronics EE-4460 series Epoxy and Cotronics EE-4461 series Epoxy.

Sealants of the invention are diluted with a sufficient quantity of solvent to allow penetration (e.g., micropenetration) of a thermal spray coating, thereby producing a extensively diluted sealant. In embodiments where the sealant is an epoxy, the solvent may be added either before or after the epoxy is combined with a hardener (e.g., a dihydric alcohol). In certain embodiments, a diluted sealant composition comprises at least 30% by weight, at least 40% by weight or at least 50% by weight solvent, such as 30-70% by weight, 35-60% by weight, 40-50% by weight or 50-60% by weight solvent. Third, the sealant is applied 215. In certain embodiments, the diluted sealant is spread over the entire surface of the coating, and the sealant is added until adsorption stops and a wet layer is left standing on the coated surface. The sealant can be directly applied, for example, using a brush, cloth, wiper, squeegee, or similar spreader, or by pouring the epoxy sealant directly onto the surface and spreading with the brush, cloth, wiper, squeegee or similar spreader. Additional sealant can be added if bubbles appear and/or a portion of the surface appears dry. In certain embodiments, the sealant remains on the surface uncured for 5-60 minutes, such as 10-45 minutes or 15-30 minutes. Preferably, excess sealant is removed after application and before curing.

Sealing can be conducted at a temperature of 120-150° F. (49-66° C.), such as 125-140° F. (52-6° C.) or 130-135° F. (54-57° C.).

In certain embodiments, the sealant is applied to the coating without wetting of the coating surface by a wetting agent (e.g., toluene, acetone, xylenes, alcohols).

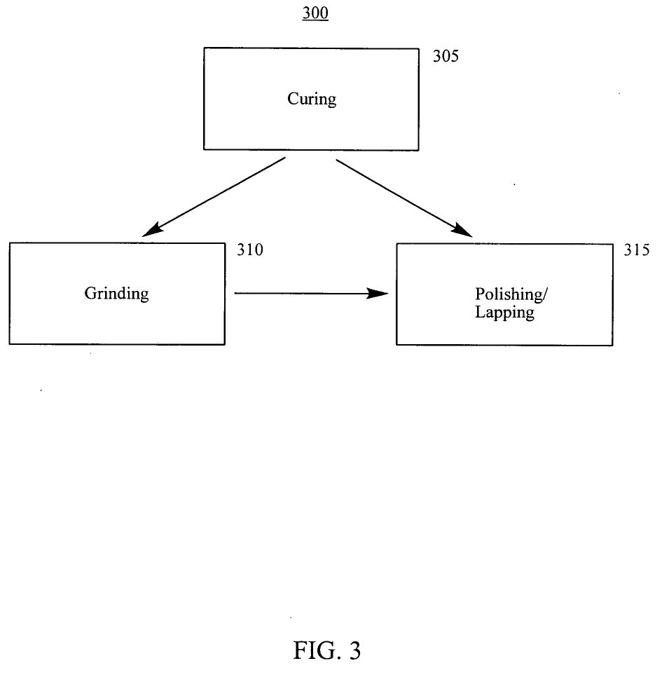

Optional post-application steps 300 are represented in FIG. 3. Once a sealant has been applied to a thermal spray coating and the excess is removed, the sealant can be cured 305 (e.g., thermoset). A thermal component to the curing process may occur either immediately after an initial cure at room temperature or after application without a room temperature curing. In one embodiment, the contents of a Cotronics EE4460 kit diluted by acetone is cured at 250° F. for 4 hours followed by a post-cure cycle at 300° F. for2 hours. In another embodiment, the contents of a Cotronics EE4461 kit diluted by acetone is cured at room temperature for 24 hours followed by a post-cure cycle at 250° F. for 4 hours.

In addition, sealed coatings of the invention are optionally ground 310, and polished and/or lapped 315 following the sealing process. Grinding is used in certain embodiments to produce a uniform surface. Lapping can be used to produce, for example, a 1-20 microinch or 2-10 microinch Ra surface finish. Such surfaces advantageously have a flatness of no more than 5, 4, 3, 2 or 1 helium light bands. In certain embodiments, grinding occurs before lapping and/or polishing.

In certain embodiments, the coatings and sealants of the invention are applied to a substantially planar surface. For example, such surfaces are not pitted and/or are not bent by more than 5°, 4°, 3°, 2° or 1°.

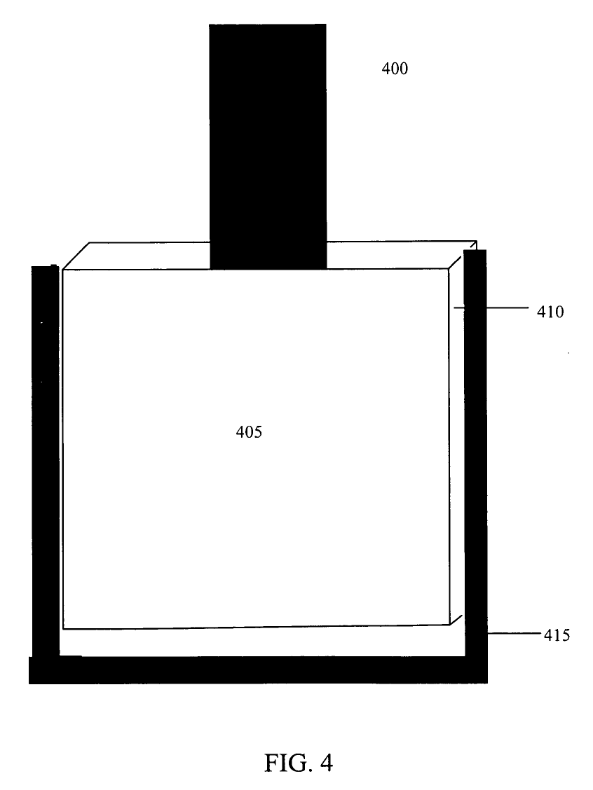

Sealed coatings of the invention are particularly useful in oilfield applications, because of the high pressure and/or corrosive gases and liquids encountered in typical operating conditions. One example of an oilfield application is in gate valves, as shown in FIG. 4. A gate valve is a type of valve that often includes a substantially rectangular-shaped gate that is moved by an operator in and out of the valve body to control the fluid. A gate valve also includes an annular or ring-shaped seat member that seals against the gate. Depending on gate valve design, one seat member may be disposed on either side of the gate, or alternatively, additional seat members may be disposed adjacent the seat member, which seat members are involved in the sealing of the valve. The additional seat members seal the passage between the seat member and body pocket. Another configuration of valve involves a substantially circular or ovoid gate that is rotated into place to form a seal.

In certain embodiments, one or more surfaces of a gate valve (e.g., gates 410, seat members 415) contacting the fluid flow include the sealed coating described herein. Nevertheless, even surfaces not involved directly in forming a seal 405 may be sealed according to the invention, particularly if the surface can be worn by friction, corrosion or pressure. Gate valves that are suitable for accepting the sealed coating of the invention include those described in U.S. Pat. Nos. 5,320,327, 5,445,359, 5,762,089, 6,691,981, and 7,255,329, the contents of which are incorporated herein by reference.

Sealed coatings of the invention can be tested by a variety of methods. One method is a 30 day salt spray corrosion test, such as ASTM B119. Another method is a nitrogen pressure test of 10 kpsi nitrogen for 15 minutes. A successfully sealed coating is one where the coating is not corroded or otherwise worn during the testing process to an unacceptable degree and leak tight, as measured by a standard technique.

### EXEMPLIFICATION

### Example 1

### Preparation

Parts to be sealed are kept clean and dry after thermal spray coating and prior to sealing. Parts are generally sealed within 4 hours of thermal spray coating.

The sealing hot plate is heated to a stabilized temperature of 135° F. If a part has been coated, is still above the sealing temperature of 135° F. and is massive enough that it will not cool down more than 5° F. during the 15 minute sealing time, a hot plate is not necessary. The part can be sealed as soon as it cools down to 135° F. If the parts to be sealed have been coated and have not yet cooled below 140° F., then the parts can be placed on the hot plate. If the parts to be sealed have cooled below 130° F., the parts must be warmed back up until they are stabilized at 130-135° F. This can be done in a warming oven or on the sealing hot plate. If not yet done, the the parts to be sealed are placed on the sealing hot plate (stabilized at 135° F.) with the coated surface that is to be sealed facing up.

### Epoxy Dilution

Enough Cotronics EE-4460 series Epoxy is prepared to cover the number of parts to be sealed. Generally, a 25 g kit is capable of sealing approximately 100 square inches. A 2 oz jar of epoxy resin is opened and the entire contents of hardener syringe is dispensed into the resin jar. The epoxy is mixed thoroughly. Acetone (16.5 ml, 12.5 g) is added to the mixed epoxy in the jar, and the jar shaken for 1 minute.

### Application

When the surface of the parts is in the 130-135° F. range, sealing can begin. The part temperature is maintained in the 130-135° F. range during the entire 15 minute sealing application time. The epoxy sealant mix is spread over the entire surface of the coating, and the sealant is added until adsorption stops and a wet layer is left standing on the coated surface. The sealant can be applied using a brush or by pouring the epoxy sealant directly onto the part and spreading with a brush or other means such as a cloth, wiper, or squeegee. The entire surface, including the edges, is thoroughly wetted with a layer of liquid sealant “standing” on the surface. The entire surface is wetted with liquid sealant for 15 minutes. Sealant is added if needed to areas that become unwetted due to evaporation or bubbles popping. There should be no bubbles on a finished sealed surface. After 15 minutes, sealant is wiped off.

### Curing

Gates are placed in an oven preheated to 250-270° F. Once all gates reach a minimum of 250° F., a timer is started for four hours of cure time, with temperature maintained at least 250° F. for the entire four hours.

After the completion of the four hour cure time, the oven temperature is increased to 300-320° F. Once all gates reach at least 300° F., a timer is started for a two hour post cure, with temperature maintained at a minimum of 300° F. for the entire two hours of post cure. After the two hour post-cure cycle is completed, the gates are cooled to room temperature.

### Cleanup and Finishing

Uncured epoxy can be cleaned off surfaces with acetone. Grinding or finishing of sealed gates is done after oven curing cycles have been completed and the gates return to room temperature.

### Example 2

### Preparation

Parts to be sealed are prepared as in Example 1.

### Epoxy Dilution

Epoxy is diluted as in Example, with the exception that Cotronics EE-4461 series Epoxy was used instead of EE-4460 series Epoxy.

### Application

Epoxy was applied as in Example 1.

### Curing

Gates are allow to cure for a period of 24 hours at room temperature (60-80° F.). After the 24 hour cure room temperature cycle is completed, the gates are placed in an oven preheated to 250-270° F. Once the gates reach a minimum of 250° F., a timer is started for 4 hours of post-cure time, with temperature maintained at least 250° F. for the entire 4 hours. After the 4 hour post-cure cycle is completed, the gates are cooled to room temperature.

### Cleanup and Finishing

Cleanup and finishing is conducted as in Example 1.

### Results

The sealed coatings described above have been tested and compared to coatings either prepared using different methods (e.g., different order of certain steps) or different components. The results showed that sealed coatings prepared according to the methods described herein and using the components disclosed herein were substantially superior to sealed coatings prepared via alternative methods.

Two pucks had an HVOF WC—Co—Cr coating applied. One puck remained as-coated and the other puck was sealed with the composition of Example 2 and cured only at room temperature. This sealed puck had a darker surface, which is typical of a surface that has been sealed. Penetration into the coating for at least 0.001″ or more was strongly indicated by virtue of the resistance to pressurized gas testing when the sealant was applied and 0.001″ or more of the HVOF coating is removed by grinding, although the exact penetration depth has not been determined. In comparison, HVOF coatings that do not get sealed in this manner, or by some alternative means or methods, are prone to failure.

Alternative Solvents

Tests were also conducted using alcohols in place of acetone as a diluent. Acetone more effectively dissolved the sealants tested, thereby lowering the viscosity. In contrast, alcohols tended to increase the drying times necessary and may increase the likelihood of the resin separating from the coating.

Alternative Modes of Sealing

In comparison to HVOF coatings sealed according to the sealing methodology described above, HVOF coatings failed when they were sealed by several other techniques. For example, one coating failed when it was ground prior to sealing. Second, a phenolic (Metco AP) sealed-coating produced inconsistent results and generally failed under nitrogen pressure testing, although it could not be determined whether the failure occurred because of insufficient dilution or the phenolic sealant itself. Similarly, paint and lacquer sealants were ineffective in protecting the coating. Third, epoxy resins applied after 10-20 weight % dilution did not adequately protect the coating.

### Equivalents

While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations.

### INCORPORATION BY REFERENCE

All publications and patents mentioned herein, including those items listed below, are hereby incorporated by reference in their entirety as if each individual publication or patent was specifically and individually indicated to be incorporated by reference. In case of conflict, the present application, including any definitions herein, will control.

1. A composition comprising a thermal spray coating and a thermally-cured sealant, wherein the sealant penetrates the coating sufficiently to be resistant to one or more of high pressure fluids, corrosive fluids, wear and erosion.

2. The composition of claim 1, wherein the sealant penetrates the coating to a depth of at least 0.05 mm.

3. The composition of claim 1, wherein the sealant is applied to the coating by diluting the sealant with at least 30% by weight of a suitable solvent.

4. The composition of claim 3, wherein the sealant is applied to the coating by diluting the sealant with at least 40% by weight of a suitable solvent.

5. The composition of claim 4, wherein the sealant is applied to the coating by diluting the sealant with at least 50% by weight of a suitable solvent.

6. The composition of claims 1, wherein the coating is a high velocity oxygen-fuel deposition (HVOF) coating.

7. The composition of claim 6, wherein the coating is a tungsten carbide-cobalt-chromium coating.

8. The composition of claim 7, wherein the coating is a WC-10Co-4Cr coating and contains no more than one percent by weight of iron.

9. The composition of claim 6, wherein the coating is a tungsten carbide-cobalt coating, a titantium carbide-iron coating, a titantium carbide-cobalt-chrome coating or a chrome carbide-nickel chrome coating.

10. The composition of claims 1, wherein the sealant is a thermosetting epoxy resin.

11. The composition of claim 1, wherein the composition is suitable for oilfield service.

12. The composition of claim 1, wherein the coating and sealant are applied to a substantially planar surface.

13. A gate valve comprising the composition of claims 1.

14. A method for protecting thermal spray coatings, comprising extensively diluting a thermosetting sealant and applying the sealant to the coating, thereby protecting the coating.

15. The method of claim 14, wherein the sealant is applied to the coating by diluting the sealant with at least 30% by weight of a suitable solvent.

16. The method of claim 15, wherein the sealant is applied to the coating by diluting the sealant with at least 40% by weight of a suitable solvent.

17. The method of claim 16, wherein the sealant is applied to the coating by diluting the sealant with at least 50% by weight of a suitable solvent.

18. The method of claims 14, wherein the coating is a high velocity oxygen-fuel deposition (HVOF) coating.

19. The method of claim 18, wherein the coating is a tungsten carbide-cobalt-chromium coating.

20. The method of claim 19, wherein the coating is a WC-10Co-4Cr coating and contains no more than one percent by weight of iron.

21. The method of claim 18, wherein the coating is a tungsten carbide-cobalt coating, a titantium carbide-iron coating, a titantium carbide-cobalt-chrome coating or a chrome carbide-nickel chrome coating.

22. The method of claims 14, wherein the sealant is a thermosetting epoxy resin.

23. The method of claim 14, wherein the protected thermal spray coating is suitable for oilfield service.

24. The method of claim 14, further comprising curing the sealant after it is applied.

25. The method of claim 14, further comprising grinding the coating after the sealant is applied.

26. A method of preparing a sealed thermal spray coating, comprising extensively diluting a thermosetting sealant and applying the sealant to the coating, thereby protecting the coating.

27. The method of claim 26, wherein the sealant is applied to the coating by diluting the sealant with at least 30% by weight of a suitable solvent.

28. The method of claim 27, wherein the sealant is applied to the coating by diluting the sealant with at least 40% by weight of a suitable solvent.

29. The method of claim 28, wherein the sealant is applied to the coating by diluting the sealant with at least 50% by weight of a suitable solvent.

30. The method of claim 26, wherein the coating is a high velocity oxygen-fuel deposition (HVOF) coating.

31. The method of claims 26, wherein the sealant is a thermosetting epoxy resin.
